(19) United States
(12) Patent Application Publication
(10) Pub. No.: US 2013/0103903 A1
(43) Pub. Date: Apr. 25, 2013

(54) Methods And Apparatus For Reusing Prior Tag Search Results In A Cache Controller

(71) Applicants: Vidyalakshmi Rajagopalan, Bangalore (IN); Archna Raj, Bangalore (IN); Sharath Kashyap, Bangalore (IN); Anuj Soni, Bangalore (IN)

(72) Inventors: Vidyalakshmi Rajagopalan, Bangalore (IN); Archna Raj, Bangalore (IN); Sharath Kashyap, Bangalore (IN); Anuj Soni, Bangalore (IN)

(21) Appl. No.: 13/277,367

(22) Filed: Oct. 20, 2011

(51) Int. Cl. G06F 12/08

(52) U.S. Cl. 711/118; 711/E12.017

(57) ABSTRACT

Methods and apparatus are provided for reusing prior tag search results in a cache controller. A cache controller is disclosed that receives an incoming request for an entry in the cache having a first tag; determines if there is an existing entry in a buffer associated with the cache having the first tag; and reuses a tag access result from the existing entry in the buffer having the first tag for the incoming request. An indicator can be maintained in the existing entry to indicate whether the tag access result should be retained. Tag access results can optionally be retained in the buffer after completion of a corresponding request. The tag access result can be reused by (i) reallocating the existing entry to the incoming request if the indicator in the existing entry indicates that the tag access result should be retained; and/or (ii) copying the tag access result from the existing entry to a buffer entry allocated to the incoming request if a hazard is detected.

### FIELD OF THE INVENTION

The present invention relates generally to buffered cache controllers and, more particularly, to improved techniques for processing address tags in a buffered cache controller.

### BACKGROUND OF THE INVENTION

A cache memory stores data that is accessed from a main memory so that future requests for the same data can be provided to the processor faster. Each entry in a cache has a data value from the main memory and a tag specifying the address in main memory where the data value came from. When a read or write request is being processed for a given main memory address, the tags in the cache entries are evaluated to determine if a tag is present in the cache that matches the specified main memory address. If a match is found, a cache hit occurs and the data is obtained from the cache instead of the main memory location. If a match is not found, a cache miss occurs and the data must be obtained from the main memory location (and is typically copied into the cache for a subsequent access).

A cache controller typically schedules read and write requests to cache memories. Due to the computational power of the processors making the requests, as well as the use of shared caches, cache controllers typically handle a number of outstanding transactions simultaneously. Read and write requests processed by a cache controller are stored in a corresponding read or write request buffer during the access period. The tag bits in the address field of incoming read or write requests are compared during a tag access with the tag bits of the existing pending requests in the buffers to avoid hazards. A hazard occurs when the tag bits of a new entry match the tag bits of an existing older valid entry in the buffer. A read after write (RAW) hazard, for example, occurs when a read instruction refers to a result that has not yet been calculated or retrieved.

To avoid hazards, older entries are typically allowed to complete and a new entry with a potential hazard is stalled until the conflicting older entry completes. In the event of a potential hazard, the tag access for the new entry is processed only after the hazard is resolved (i.e., after the instruction associated with the older valid buffer entry completes). After the hazard is resolved, the tag access is performed to determine if the cache line identified by the tag address in the incoming entry already exists in the cache memory. Thus, a tag access is delayed in event of a hazard. A need therefore exists for improved techniques for processing tags in a cache controller.

### SUMMARY OF THE INVENTION

Generally, methods and apparatus are provided for reusing prior tag search results in a cache controller. According to one aspect of the invention, a cache controller is disclosed that receives an incoming request for an entry in the cache having a first tag; determines if there is an existing entry in a buffer associated with the cache having the first tag; and reuses a tag access result from the existing entry in the buffer having the first tag for the incoming request.

According to a further aspect of the invention, an indicator, such as a tag valid bit, can be maintained in the existing entry to indicate whether the tag access result should be retained. In addition, tag access results can optionally be retained in the buffer after completion of a corresponding request. In this manner, the tag access result can be reused by reallocating the existing entry to the incoming request if the indicator in the existing entry indicates that the tag access result should be retained. In addition, the tag access result can be reused by copying the tag access result from the existing entry to a buffer entry allocated to the incoming request if a hazard is detected. The cache can then be accessed using the reused tag access results.

A more complete understanding of the present invention, as well as further features and advantages of the present invention, will be obtained by reference to the following detailed description and drawings.

### BRIEF DESCRIPTION OF THE DRAWINGS

FIG. 1 illustrates a conventional main memory and associated cache memory;

FIG. 2 illustrates a conventional cache controller;

FIG. 3 is a flow chart describing an exemplary implementation of a conventional cache control process;

FIG. 4 is a sample table illustrating an exemplary read or write buffer incorporating aspects of the present invention;

FIG. 5 is a flow chart describing an exemplary implementation of a cache control process incorporating aspects of the present invention;

FIG. 6 illustrates the processing of a Write/Read request for a tag using an inheritance of tag search results in the presence of a hazard with an existing pending request for the same tag and

FIG. 7 illustrates the processing of a Write/Read request for a tag using a re-allocation of an existing buffer entry in tag retention mode for the same tag to the new request.

### DETAILED DESCRIPTION

The present invention provides methods and an apparatus for improving the performance of buffered cache controllers. As previously indicated, with conventional techniques, in the event of a potential hazard, the tag access for the new entry is processed only after the hazard is resolved (i.e., after the instruction associated with the older valid buffer entry completes). The present invention recognizes that in the event of a hazard, the required tag results are already available in the buffer from the most recent preceding access to the same cache line.

According to one aspect of the invention, referred to herein as tag retention, the tag result of a prior tag access is retained in the buffer entry after completion of the request. Any subsequent access to the same cache line will reuse the existing tag access result. Thus, another exclusive tag access is not required, thereby saving clock cycles. In one exemplary implementation, a “tag valid” bit (tag_val) is added to each cache buffer entry indicating the validity of the tag access results.

For every new read or write request processed by the cache controller, the tag field in the request is compared with the tags of other entries in the buffer to check for hazards. If there is no hazard (i.e., no active transaction is pending to the accessed cache line), the cache controller determines whether there is a buffer entry with a matching tag and having the tag access results available (i.e., the ‘tag_val’ bit is set). For example, if the ‘tag_val’ bit is set to a value of binary one in the matched entry, then tag access results are already in the buffer and a fresh tag access for the new buffer entry is not required. In the case of a hazard, the tag state of the older entry is copied into the newer entry upon resolution of the hazard and hence a new tag access is avoided. The newly requested read/write request could directly proceed to access the cache line from the data cache memory without the tag access, thereby reducing access latency and dynamic power consumption and improving performance.

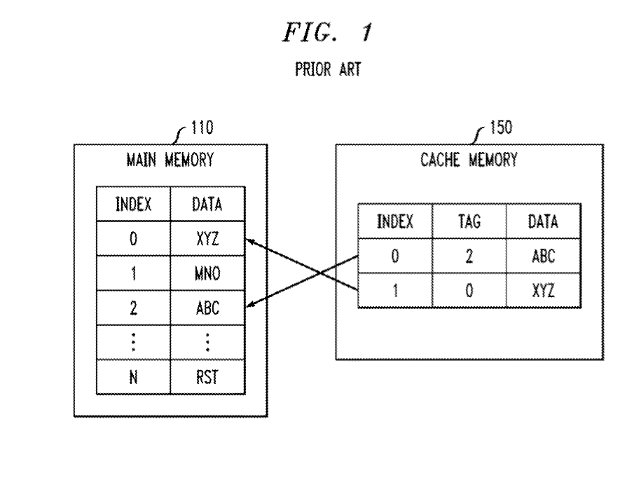

FIG. 1 illustrates a conventional main memory 110 and associated cache memory 150. As shown in FIG. 1, each entry in the main memory 110 comprises an index indicating the main memory address and the corresponding data. In addition, each entry in the cache memory 150 comprises an index indicating the cache memory address, a tag indicating the corresponding main memory address where the data came from, and the corresponding data.

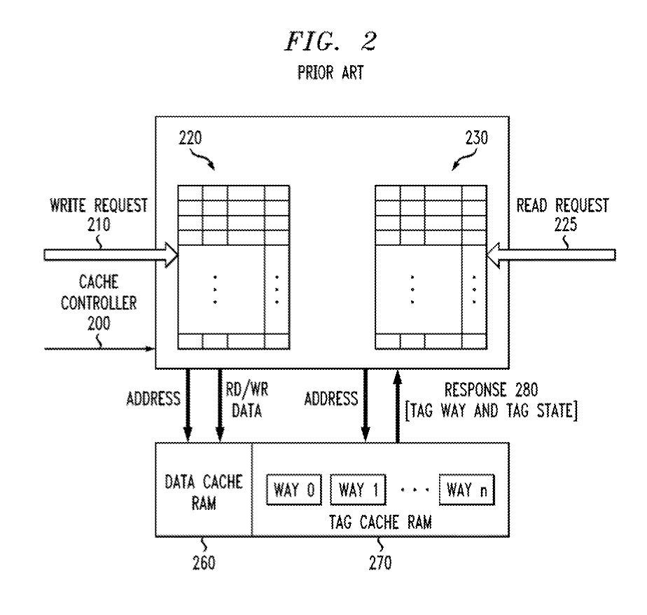

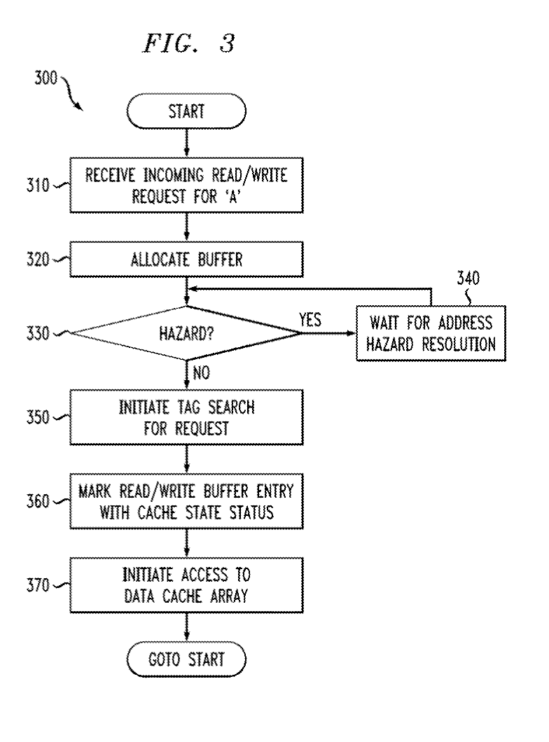

FIG. 2 illustrates a conventional cache controller 200. As previously indicated, a cache controller 200 typically processes the read and write requests to a cache memory. As shown in FIG. 2, a write request 210 is stored by the cache controller 200 in a corresponding write buffer 220 during the access period. Similarly, a read request 225 is stored by the cache controller 200 in a corresponding read buffer 230 during the access period. The write buffer 220 and read buffer 230 have a fixed number of entries. For example, if a read buffer 230 has 16 entries, the read buffer 230 can accept at most 16 entries for reading the cache. Each entry in the read buffer 230 and write buffer 220 comprises a number of fields to capture the details of the incoming read or write request, respectively. For example, a read request comprises address and command field in addition to a number of other fields. The processing of read and write requests by a conventional cache controller 200 is discussed further below in conjunction with FIG. 3.

Generally, as shown in FIG. 2, the cache controller 200 performs a search of a tag cache RAM 270 to determine the tag state and tag way of the address specified in the request. The tag search response 280 thus comprises the tag state indicating the state of cache line and the tag way identifying the memory array in which the tag results and data are available for this cache line in a set associative cache. The read or write request is then processed by providing the requested address and corresponding read or write data to a data cache RAM 260 to fetch the cached data.

FIG. 3 is a flow chart describing an exemplary implementation of a conventional cache control process 300. As shown in FIG. 3, the exemplary conventional cache control process 300 receives an incoming read/write request for a memory location ‘A’ during step 310. Thereafter, a read or write buffer 220, 230 is allocated to the request during step 320.

A test is performed during step 330 to determine if a potential hazard exists with other entries. If it is determined during step 330 that a potential hazard exists, then the conventional cache control process 300 waits during step 340 for the hazard to resolve. If, however, it is determined during step 340 that a hazard does not exist, then a tag search is initiated for the request during step 350.

The allocated read/write buffer entry is then marked during step 360 with the cache state status.

Thus, as previously indicated, with the conventional cache control process 300, the tag access for the new entry is processed only after a hazard is resolved (step 330). The present invention recognizes that upon a subsequent request to same cache line, the required tag results are already available in the buffer from the most recent preceding access to the same cache line. The present invention saves clock cycles for this scenario when an access to same cache line reuses the tag state information from a previous access.

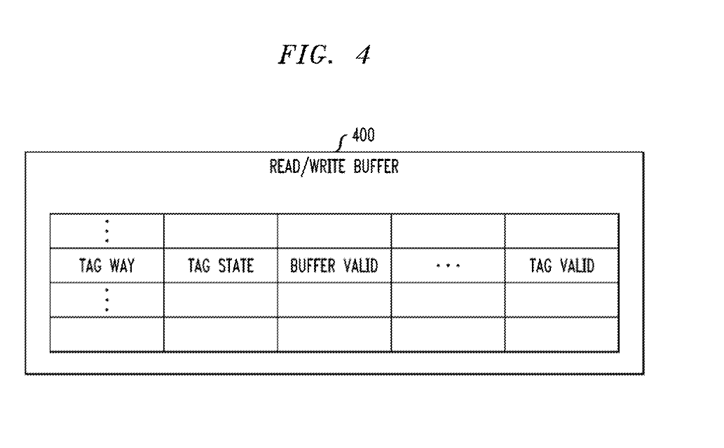

FIG. 4 is a sample table illustrating an exemplary read or write buffer 400 incorporating aspects of the present invention. As shown in FIG. 4, the exemplary read or write buffer 400 comprises a number of conventional fields including a Tag Way field and Tag State field, to record the information returned from the tag search, and a Buffer Valid field. As indicated above, the tag state indicates the state of cache line and the tag way identifies the memory array in which the tag results and data are available for this cache line in a set associative cache. The buffer valid field indicates whether the request associated with the entry is active or has retired.

In addition, as indicated above, an exemplary implementation of the present invention adds a “tag valid” bit (tag_val) to each entry in the cache buffers 400 indicating the validity of the tag access results.

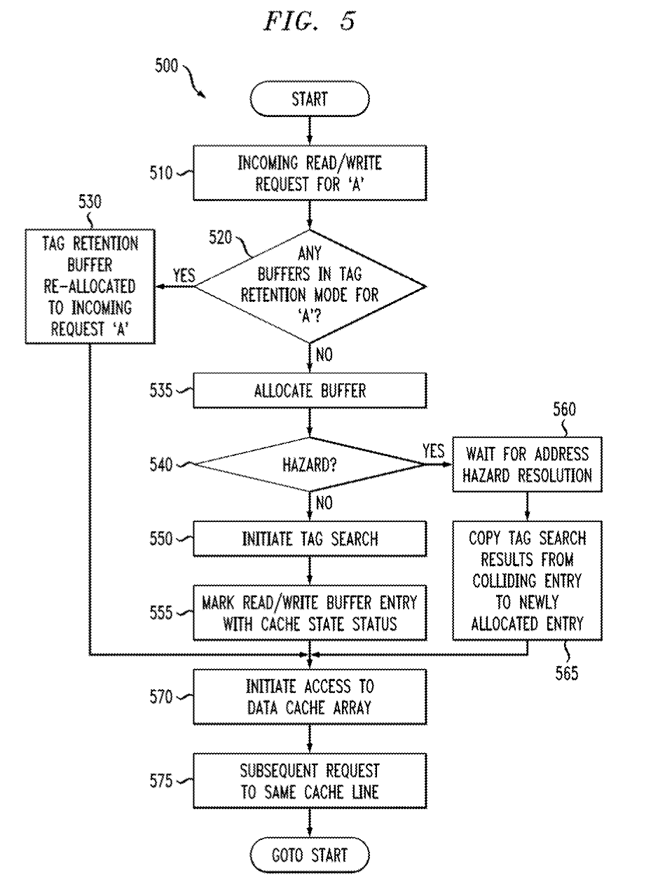

FIG. 5 is a flow chart describing an exemplary implementation of a cache control process 300 incorporating aspects of the present invention. As shown in FIG. 5, the exemplary cache control process 500 receives an incoming read/write request for a memory location ‘A’ during step 510.

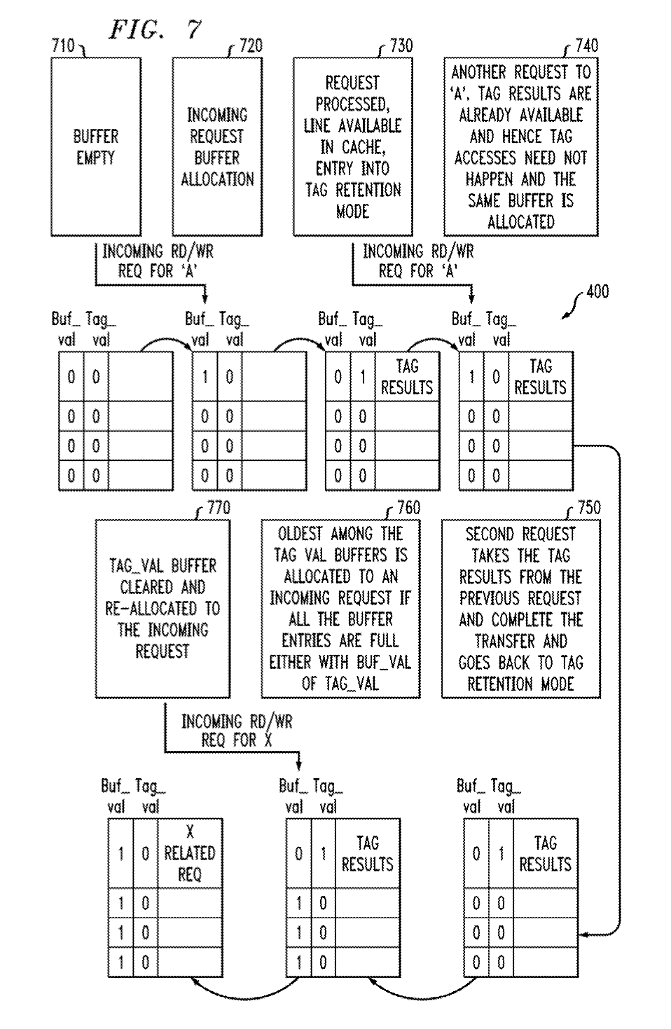

A test is performed during step 520 to determine if any buffers are in a tag retention mode for address ‘A’. If it is determined during step 520 that a buffer is in a tag retention mode for address ‘A,’ then the tag retention buffer is re-allocated during step 530 to the incoming request for ‘A,’ thereby saving clock cycles relative to conventional techniques. Program control then proceeds to step 570. This scenario is as discussed further below in conjunction with FIG. 7.

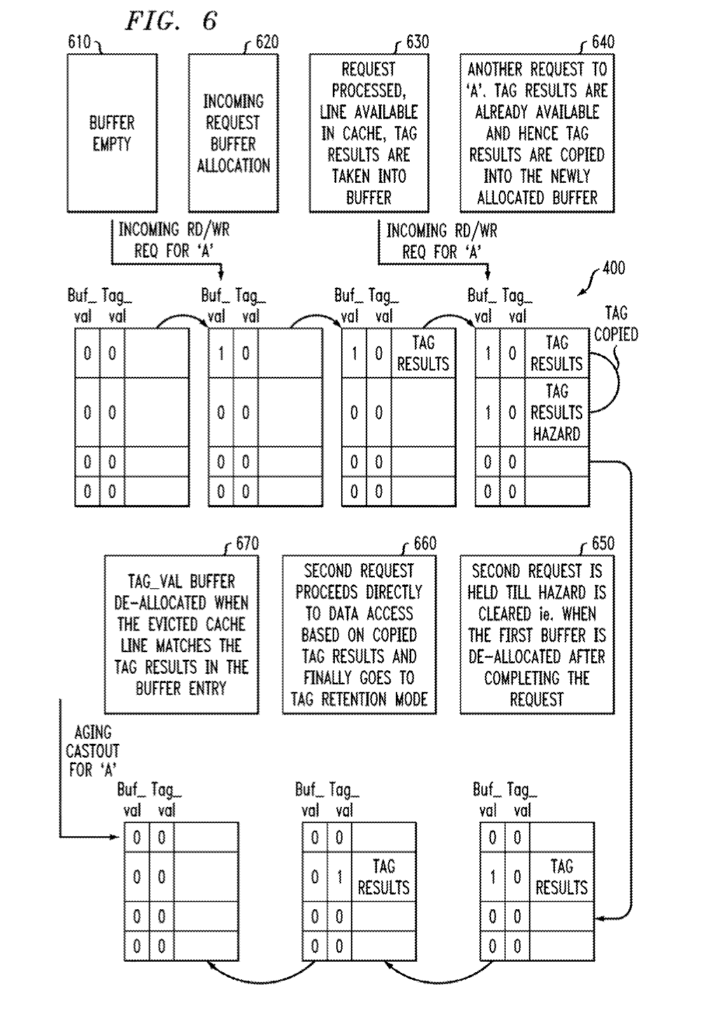

If, however, it is determined during step 520 that a buffer is not in a tag retention mode for address ‘A,’ then a buffer is allocated to the request during step 535 (and the corresponding Buffer Valid bit for the buffer is set to ‘1’). A test is then performed during step 540 to determine if a potential hazard exists with other entries. If it is determined during step 540 that a potential hazard exists, then the cache control process 500 waits for the address hazard to resolve during step 560 and then copies the tag search results from the colliding entry to the newly allocated entry during step 565, thereby saving clock cycles relative to conventional techniques. This scenario is as discussed further below in conjunction with FIG. 6.

If, however, it is determined during step 540 that a hazard does not exist, then a tag search is initiated for the request during step 550 and the read/write buffer entry is marked during step 555 with the cache state status.

The access to the data cache array is initiated during step 570. The present invention recognizes that upon a subsequent request to same cache line during step 575, performance can be improved by reusing the cache results that are already present in the cache buffer 400. For example, as discussed further below in conjunction with FIG. 6, in the event of a hazard, the present invention improves the performance of cache memory access by using the tag access results directly from the older entry for the same cache line. The process of skipping tag memory access results in performance improvement.

In addition, as discussed further below in conjunction with FIG. 7, when a buffer entry has a matching tag to an incoming request and the tag valid bit has been set for the entry (i.e., the buffer entry is in the tag retention mode), then the new request is directly allocated in the same buffer entry as the prior request and program control proceeds directly to data cache access by making use of the available tag results.

If the cache controller 200 determines during step 540 that an incoming Write/Read request does not create a hazard with another entry in the buffer, then the tag look-up takes place during step 550 and the results are stored in the corresponding tag_state field within the buffer entry 400 during step 555. The request is then processed during step 570 according to the tag look-up results. The buffer entry remains allocated even after completion of the request (e.g., set the Buffer Valid bit to “0” and set the Tag Valid bit to “1”). In other words, a new incoming request to the same tag could enter this buffer, which could make use of the tag_state field value already within the buffer, hence avoiding another tag look-up, as discussed further below in conjunction with FIG. 7.

Inheriting Tag Search Results Upon Hazard

FIG. 6 illustrates the cache controller 200 of FIG. 2 processing a Write/Read request for a tag “A,” while there is already an existing Write/Read request for tag “A” in another buffer entry for which the Buffer Valid bit is set, and the buffer entry is not in tag retention mode (e.g., Buf_val=1 and Tag_val=0). In other words, the already existing request is not completed yet when the new request regarding tag “A” arrives to the cache controller 200. Since there were no entries for tag “A” in a tag retention mode (step 520), a new buffer is allocated for this new incoming request at step 540 (e.g., Buf_val is set to “1” and Tag_val remains “0”). A hazard with an existing entry for tag “A” is detected by the cache controller 200 at step 540, and once the hazard resolves (step 560), the tag_state results are copied from the existing buffer tag_state field (having same tag “A”) to the new entry at step 565. Thus, the second request with tag “A” is held in the buffer during step 560 until the hazard is cleared, i.e., when the previous buffer with a Write/Read request to same tag “A” is completed it is de-allocated (Buf_val/‘0’ and Tag_val=‘0’). Now, the second request to same tag “A” could be processed by using the tag_state results of the previous buffer and finally the buffer goes into tag retention mode (Buf_val=‘0’, Tag_val=‘1’). In case of cache line eviction having the same tag “A”, the Tag_val for the buffer having tag “A” is set to “0” (i.e., the buffer is de-allocated (Buf_val=‘0’, Tag_val=‘0’)).

As shown in FIG. 6, at a time 610, the buffer 400 is initially empty. Then, at a time 620, the cache controller 200 processes an incoming Read/Write request for address “A.” A buffer entry is allocated and the corresponding. Buffer Valid bit is set to “1.” The request is then processed and the tag results (TAG RES) are placed in the butler entry at time 630. Thereafter, at a time 640, a second request arrives for tag “A”. Thus, a hazard is encountered (step 540). The second request for tag “A” is processed at a time 650, before the prior request has completed. The second request waits at time 650 (step 560) for the hazard to resolve (when the buffer is de-allocated after completing the request). It is noted that the tag results are already available for tag “A” from the prior request and thus the results can be copied at time 650 into the newly allocated buffer entry (step 565). In this manner, the new request inherits the tag results from the prior entry.

The second request proceeds at time 660 directly to the data access (step 570 of FIG. 5) based on the tag results copied from the prior entry and then goes into tag retention mode (Tag_Val is set to 1). Finally, at time 670, the buffer is de-allocated when the evicted cache line matches the tag results in the buffer entry.

Re-Allocating Existing Buffer Entry in Tag Retention Mode to New Request

FIG. 7 illustrates the cache controller 200 of FIG. 2 processing a Write/Read request for a tag “A,” while there is an existing valid buffer in tag retention mode with the same tag “A” and the associated request had completed in the recent past (i.e., Buf_val=0 and Tag_val=1). Thus, the existing buffer contains the tag_state field results for a prior request with the same tag “A.” The present invention recognizes that the tag state can be re-used when a new Write/Read request with tag “A” is being processed after another existing Write/Read request with the same tag “A” was completed and remains in tag retention mode. In one exemplary embodiment, the tag state is re-used by re-allocating the existing buffer entry for the prior request to the new request. Generally, the new incoming request with tag “A” is allocated to the existing buffer and the buffer again becomes valid (Buf_val=‘1’) and the Tag_val remains “0”. Rather than doing a tag look-up for the incoming Write/Read request, the tag_state result for tag “A” in the existing buffer is used, which provides significant savings on tag access.

As shown in FIG. 7, at a time 710, the buffer 400 is initially empty. Then, at a time 720, the cache controller 200 processes an incoming Read/Write request for address “A.” A buffer entry is allocated and the corresponding Buffer Valid bit is set to “1.” The request is then processed and the tag results (TAG RES) are placed in the buffer entry at time 730. The buffer entry is placed in tag retention mode. Generally, the last buffer entry which completes the request for a given address (‘A’) goes into tag retention mode, as there are no other buffer entries to inherit the tag results (i.e., no hazard based inheritance is possible). For example, in FIG. 6 there was another buffer entry for the same address holding a read/write request which arrived after this request and hence, tag results will be copied to the pending buffer entry and hence the older buffer entry need not go into tag retention mode. The newer request to address ‘A’ arrived before the previous request was completed (say the data access for the older read/write request is pending though the tag results are already available).

Thereafter, at a time 740, a second request arrives for tag “A” is received by the cache controller 200. The tag results are already in the existing buffer entry, and the tag results can be re-used by allocating the incoming request to the existing buffer entry for tag “A” (step 530 of FIG. 5). In this manner, a new tag access need not be performed.

As shown in FIG. 7, at a time 750, the cache controller 200 uses the tag results from the previous request for tag “A” and completes the transfer (step 570 of FIG. 5) and the buffer valid bit to “0”. The buffer entry then returns to a tag retention mode by setting the tag valid bit to “1.”

At a time 760, there is a new incoming request for a tag “x” and all of the buffer entries are full (i.e., the buffer valid bit or the tag valid bit is set). Thus, in one exemplary implementation, the oldest buffer entry among the entries in tag retention mode is allocated to the new request for tag “x.” Thus, the tag valid bit for the newly allocated buffer entry is cleared at time 770 and the buffer entry is re-allocated to the incoming request for tag “x.” The newly allocated buffer entry is considered to be a new entry and a tag look-up is needed for this request.

As previously indicated, the arrangements of cache controller systems, as described herein, provide a number of advantages relative to conventional arrangements. Again, it should be emphasized that the above-described embodiments of the invention are intended to be illustrative only. In general, the exemplary cache controller systems can be modified, as would be apparent to a person of ordinary skill in the art, to incorporate the re-use of tag search results in accordance with the present invention. In addition, the disclosed tag result re-use techniques can be employed in any buffered cache controller system, irrespective of the underlying cache coherency protocol. Among other benefits, the present invention provides faster cache line access and reduced dynamic power consumption.

While exemplary embodiments of the present invention have been described with respect to processing steps in a software program, as would be apparent to one skilled in the art, various functions may be implemented in the digital domain as processing steps in a software program, in hardware by a programmed general-purpose computer, circuit elements or state machines, or in combination of both software and hardware. Such software may be employed in, for example, a hardware device, such as a digital signal processor, application specific integrated circuit, micro-controller, or general-purpose computer. Such hardware and software may be embodied within circuits implemented within an integrated circuit.

In an integrated circuit implementation of the invention, multiple integrated circuit dies are typically formed in a repeated pattern on a surface of a wafer. Each such die may include a device as described herein, and may include other structures or circuits. The dies are cut or diced from the wafer, then packaged as integrated circuits. One skilled in the art would know how to dice wafers and package dies to produce packaged integrated circuits. Integrated circuits so manufactured are considered part of this invention.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

It is to be understood that the embodiments and variations shown and described herein are merely illustrative of the principles of this invention and that various modifications may be implemented by those skilled in the art without departing from the scope and spirit of the invention.

We claim:

1. A method for controlling a cache, comprising:
receiving an incoming request for an entry in said cache having a first tag;
determining if there is an existing entry in a buffer associated with said cache having said first tag; and
reusing a tag access result from said existing entry in said buffer having said first tag for said incoming request.

2. The method of claim 1, further comprising the step of maintaining an indicator in said existing entry indicating whether said tag access result should be retained.

3. The method of claim 2, wherein said indicator comprises a tag valid bit.

4. The method of claim 2, wherein said reusing step further comprises the step of reallocating said existing entry to said incoming request if said indicator in said existing entry indicates that said tag access result should be retained.

5. The method of claim 1, wherein said reusing step further comprises the step of copying said tag access result from said existing entry to a buffer entry allocated to said incoming request if a hazard is detected.

6. The method of claim 5, further comprising the step of waiting for said hazard to resolve.

7. The method of claim 1, further comprising the step of accessing said cache using said reused tag access results.

8. The method of claim 1, further comprising the step of retaining said tag access results in said buffer after completion of a corresponding request.

9. The method of claim 1, wherein said determining step further comprises the step of comparing a tag of said incoming request to the tag field of entries in said buffer.

10. The method of claim 1, wherein said request comprises one or more of a read request and a write request.

11. The method of claim 1, wherein said tag access results comprise one or more of a tag state and a tag way.

12. A cache controller for assigning an incoming request for an entry in at least one cache to a plurality of buffer entries, each of said plurality of buffer entries configured to store a tag access result and an indicator indicating whether said tag access result should be retained, said cache controller comprising:
at least one hardware device, coupled to the plurality of buffer entries and to said at least one cache, operative to:
receive said incoming request for an entry in said cache, wherein said entry in said cache has a first tag;
determine if there is an existing entry in one of said plurality of buffer entries having said first tag; and
reuse a tag access result from said existing entry in said buffer having said first tag for said incoming request based on said indicator.

13. The cache controller of claim 12, wherein said at least one hardware device is further configured to maintain an indicator in said existing entry indicating whether said tag access result should be retained.

14. The cache controller of claim 13, wherein said indicator comprises a tag valid bit.

15. The cache controller of claim 13, wherein said tag access result is reused by reallocating said existing entry to said incoming request if said indicator in said existing entry indicates that said tag access result should be retained.

16. The cache controller of claim 12, wherein said tag access result is reused by copying said tag access result from said existing entry to a buffer entry allocated to said incoming request if a hazard is detected.

17. The cache controller of claim 16, wherein said at least one hardware device is further configured to wait for said hazard to resolve.

18. The cache controller of claim 12, wherein said at least one hardware device is further configured to access said cache using said reused tag access results.

19. The cache controller of claim 12, wherein said at least one hardware device is further configured to retain said tag access results in said buffer after completion of a corresponding request.

20. The cache controller of claim 12, wherein said at least one hardware device determines if there is an existing entry in one of said plurality of buffer entries having said first tag by comparing a tag of said incoming request to the tag field of entries in said buffer.

21. The cache controller of claim 12, wherein said request comprises one or more of a read request and a write request.

22. The cache controller of claim 12, wherein said tag access results comprise one or more of a tag state and a tag way.

23. The cache controller of claim 12, wherein said cache controller is embodied on an integrated circuit.

24. An article of manufacture for controlling a cache, comprising a tangible machine readable recordable medium containing one or more programs which when executed implement the steps of:
receiving an incoming request for an entry in said cache having a first tag;
determining if there is an existing entry in a buffer associated with said cache having said first tag; and
reusing a tag access result from said existing entry in said buffer having said first tag for said incoming request.
